(19) United States
(12) Patent Application Publication
(10) Pub. No.: US 2022/0219748 A1
(43) Pub. Date: Jul. 14, 2022

(54) CARRIAGE

(71) Applicants: Luca Ostini, Gravesano (CH); Eric Robert Warsitz, Carabbia (CH)

(72) Inventor: Giuseppe Marcello DE GREGORIO, Pedrinate (CH)

(21) Appl. No.: 17/606,200

(22) PCT Filed: Apr. 23, 2020
(86) PCT No.: PCT/IB2020/053838

§ 371 Date: Oct. 25, 2021

(30) Foreign Application Priority Data
Apr. 26, 2019 (CH) 00559/19

(51) Int. Cl. B62B 9/22

(52) U.S. Cl. CPC B62B 9/22

(57) ABSTRACT

A carriage (10) for children equipped with at least one frame (1), at least one couple of first wheels (3), at least one pivot pint (15) on which the first wheels (3) are mounted, defining a rotation axis (X-X) of the first wheels (3), at least one hinge axis (Y-Y) characterized by comprising at least one swinging device (5) and at least one drive device to drive said swinging device (5) is described; said swinging device (5) being configured so that to switch from a first configuration, in which the position of the hinge axis (Y-Y) is fixed with respect to the position of the rotation axis (X-X), and a second configuration in which the hinge axis (Y-Y) rotates with respect to the rotation axis (X-X) of the first wheels (3) and vice-versa.

### FIELD OF THE INVENTION

The present invention concerns a carriage for children, of the pram or stroller type, and in particular a carriage for children provided with a swinging device.

### KNOWN ART

As is known, when close to the birth of a first child, every parent inevitably finds himself/herself struggling with purchases of all types: changing tables, blankets, clothes and so forth; among which the purchase of the carriage (pram and/or stroller), which is always important and useful for the mom and baby, is also included.

For example, the pram is in fact the most appropriate means for transporting the child from birth until about 6 months, whereas the stroller is the most appropriate means for transporting the child from 6 months until about 3 years of age. In addition to representing a useful tool at every moment of the day of the baby and his/her mom, who can also use it as a crib on wheels, the pram is also one of the safest and most comfortable means of transport for the baby: the side edges better protect from possible shocks and temperature gaps; moreover, the position of the basket, or crib-shaped containing element, ensures a peaceful and comfortable sleep for the baby.

Moreover, the carriage (pram and/or stroller) is the best place for the child to sleep, the movement generated by the wheels often helps the child to fall asleep.

However, the Applicant has noticed that the movement generated by the wheels of the carriage is limited to a direction parallel to the surface covered by the wheels and can deviate therefrom, in a vertical direction, only due to an irregularity of the surface itself, such as a bump or slight hole.

Moreover, the Applicant has observed that parents often rhythmically pull and push the carriage forward and backward to make the child fall asleep, since such a cyclic and repeated movement has shown, in some cases, to favor the sleep of the child.

The Applicant has thus addressed the problem of making a carriage for children that is able to generate a swinging movement of the containing crib and which can favor the sleep of the child whenever needed.

### SUMMARY OF THE INVENTION

Thus, in a first aspect, the invention concerns a carriage for children equipped with at least one frame, at least one couple of first wheels, at least one pivot pin on which the first wheels are mounted, defining a rotation axis of the first wheels, at least one hinge axis, characterized by comprising at least one swinging device and at least one drive device to drive the swinging device; said swinging device comprising at least one spacer element configured to space the rotation axis from said hinge axis; the swinging device being configured so that to switch from a first configuration, in which the position of the rotation axis is substantially fixed with respect to the position of the hinge axis, to a second configuration in which the rotation axis of the first wheels rotates by a predetermined angular amount with respect to the hinge axis and/or vice-versa.

In the aforesaid aspect, the present invention can have at least one of the preferred characteristics described hereunder.

Preferably, the swinging device comprises limiting means to limit the rotation of the rotation axis of the first wheels with respect to the hinge axis.

Advantageously, the carriage comprises two pivot pins, one for each first wheel, said rotation axis of the first wheels passing through the two pivot pins.

Conveniently, the carriage comprises an assembly for locking the rotation of the rotation axis of the first wheels with respect to the hinge axis, which is configured to lock the rotation of said at least one spacer element.

Preferably, the assembly for locking the rotation comprises a first head portion arranged on the spacer element and a clamp element shaped to translate from a first position, in which it is engaged with said first head portion and locks the position of the spacer element, and a second position in which it is away from the first head portion, thus releasing the rotation of the spacer element.

Advantageously, the limiting means to limit the rotation comprise:
at least one crown wheel integral with a first wheel;
at least one lever comprising a first end; said lever being hinged to said spacer element to rotate said first end between a first position, in which said first end is engaged with said crown wheel and limits the rotation of the rotation axis of the first couple of wheels with respect to the hinge axis, and a second position in which said first end is disengaged from the crown wheel, thus allowing the rotation of the rotation axis with respect to the hinge axis.

Conveniently, the lever comprises a second end engaged with a drive shaft arranged so that a pressure exerted on the drive shaft rotates the lever in order to engage the first end with the crown wheel and a pressure exerted on the drive shaft, in the opposite direction with respect to the previous one, rotates the lever so that to disengage the first end from the crown wheel.

Preferably, the head portion comprises a cogged rack, the clamp element comprises a cogged portion shaped to be engaged with the cogged rack. Advantageously, the carriage comprises a hinge shaft for hinging said at least one spacer element to the frame; said hinge axis passing through said hinge shaft.

Conveniently, the assembly for locking the rotation of the rotation axis comprises an elastic element to push said clamp element towards said second position.

Preferably, the carriage comprises two spacer elements, one for each first wheel. Further characteristics and advantages of the invention will become clearer in the detailed description of some preferred, but not exclusive, embodiments of a carriage for children, newborns, and in particular a pram for children, preferably newborns, equipped with a swinging device according to the present invention.

### BRIEF DESCRIPTION OF THE DRAWINGS

Such description will be set forth hereunder with reference to the accompanying drawings, only provided by way of example and thus not limiting, in which:

FIG. 1 shows a perspective schematic view of a carriage, in particular a pram, equipped with a swinging device according to the present invention;

FIG. 2 is an exploded schematic view of the swinging device according to the present invention;

FIG. 3 is an enlarged schematic view of a portion of the swinging device according to the present invention;

FIG. 4 is a schematic view of the swinging device in a first configuration in which the clamp elements are engaged with the cogged rack, while the limiting means are deactivated, i.e. are not engaged with the crown wheel and do not allow the swinging of the crib element;

FIG. 5 is a schematic view of the swinging device in a second configuration in which the clamp elements are disengaged from the cogged rack, while the limiting means are engaged with the crown wheel, thus limiting the angular rotation and swinging the crib;

FIG. 6 is a schematic view of the swinging device in a third configuration in which the clamp elements are engaged with the cogged rack and the limiting means are engaged with the crown wheel, thus locking the carriage; and

FIG. 7 is a schematic view of the swinging device in a fourth configuration in which the clamp elements are disengaged with respect to the cogged rack and the limiting means are disengaged from the crown wheel, thus creating a sort of damper for the irregularities of the road surface.

### DETAILED DESCRIPTION OF EMBODIMENTS OF THE INVENTION

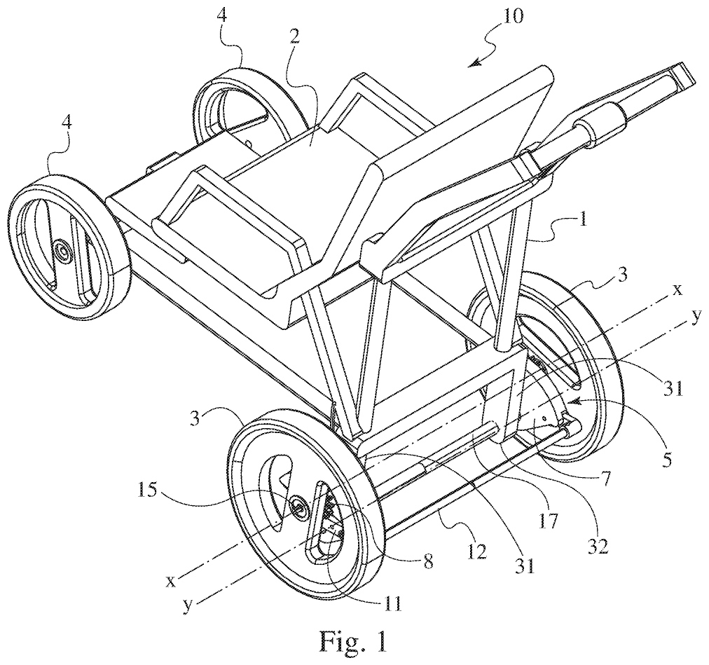

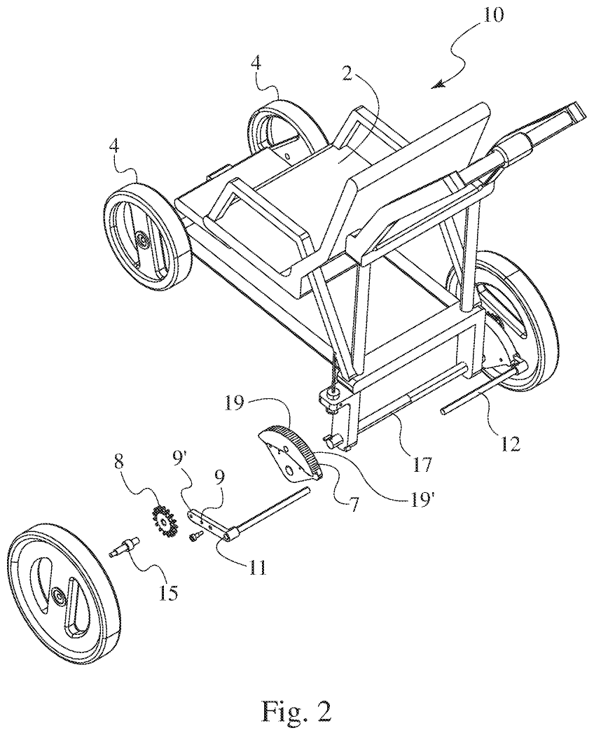

With reference to the figures, and in particular to FIGS. 1 and 2, a carriage for children, in particular newborns, according to the present invention is denoted by the numerical reference 10.

The carriage 10 is equipped with at least one frame 1, with at least one crib or seat element 2 for containing a child and with at least one couple of first, preferably rear, wheels 3. Each first wheel 3 of the couple of first wheels is mounted to a pivot pin 15 defining a rotation axis X-X of the first wheels 3.

In the embodiment shown in FIG. 1, the carriage 10 further has a couple of second, preferably front, wheels 4, but could also have a single front wheel 4 without departing from the protection scope of the present invention.

The carriage 10 has, as better described hereunder, at least one hinge axis Y-Y for hinging the frame to the couple of first wheels 3 through at least one spacer element 7.

The carriage 10 further comprises a swinging device 5 and a drive device to drive the swinging device 5.

The swinging device 5 is able to allow a swinging movement of the crib element 2 for containing the child during the movement of the carriage 10 itself, so that to facilitate the sleep of the child contained therein.

To this end, the swinging device 5 is configured so that to switch from a first configuration, in which the position, and in particular the angular position, of the rotation axis X-X is substantially fixed with respect to the position of the hinge axis Y-Y, to a second configuration in which the rotation axis X-X is free to rotate with respect to the hinge axis Y-Y of the first wheels and vice-versa, thus holding the first wheels 3 in contact with the ground.

In this second configuration, in addition to having a rotation with respect to the pivot pins 15 or hubs, the first wheels 3 further have a rotation of the entire wheel body with respect to the frame 1 or, more in particular, with respect to a part thereof, as more clearly described hereunder.

The contact of the first wheels 13 with the ground is held during the second configuration, thus forcing the crib element 2 for containing the child to a swinging movement during the movement of the carriage 10.

The drive device drives the swinging device 5 from the first to the second configuration and vice-versa. In other words, the drive device ensures that the carriage can switch from a “standard mode,” in which the swinging of the crib element 2 for containing the child is not allowed and in which the first wheels 3 only rotate with respect to their pivot pin 15 or hub, to a swinging mode in which the aforesaid swinging of the crib element 2 is allowed and in which the first wheels 3 have a rotary movement, although angularly limited, both with respect to their pivot pin 15 or hub and with respect to the hinge point for hinging to the frame, which is radially away from the hub.

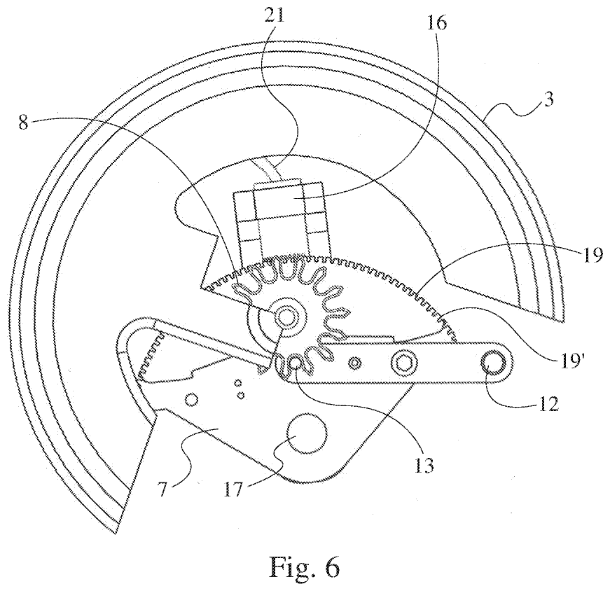

In the embodiment shown in the figures, said swinging device 5 advantageously comprises a third configuration shown in FIG. 6, in which the rotation of the first wheels 3 is locked, thus neither allowing the carriage to be able to move forward nor backward.

In other words, when the swinging device 5 is in the third configuration, the pram 10 is braked, as more clearly described hereunder.

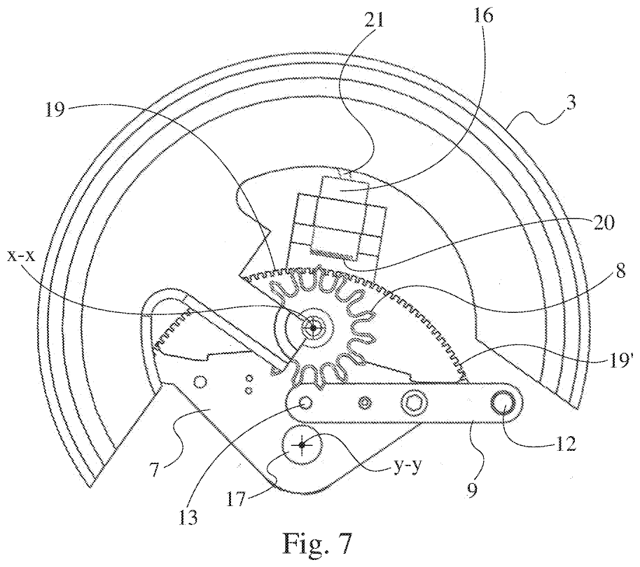

In the embodiment shown in the figures, said swinging device 5 advantageously comprises a fourth configuration shown in FIG. 7, in which the aforesaid swinging of the crib element 2 is allowed and in which the first wheels 3 have a rotary movement both with respect to their pivot pin 15 or hub and with respect to the hinge point for hinging to the frame, which is radially away from the hub, but only if induced by irregularities of the road surface.

In general, in the embodiment shown in the figures, the swinging device 5 comprises at least one spacer element 7 configured to space the rotation axis X-X from the hinge axis Y-Y.

The spacer element 7 is hinged, in a first point thereof, to a pivot pin 15 and, at another point, to the hinge axis Y-Y so that to rotate, at least partially, around the hinge axis Y-Y.

The rotation of the spacer element 7 around the hinge axis Y-Y involves the rotation of the wheel around the hinge axis Y-Y.

In the embodiment shown in FIGS. 1, 2, there are two spacer elements 7, one for each first wheel 3, and a hinge shaft 17 which hinges the two spacer elements 7 at its opposite ends.

The hinge axis Y-Y passes through the hinge shaft 17.

The hinge shaft 17 is in turn constrained to the frame 1, through the two struts 31 spaced along the extension direction of the hinge shaft 17. Each strut 31 has a seat 32 in which a length of the shaft 17 is accommodated so that to be able to rotate freely.

The two seats 32 and the shaft 17 passing through them define the hinge axis Y-Y.

The first wheels 3 of the couple of first wheels are hinged idly to two pivot pins 15 or hubs at the geometric centers of the same first wheels.

Each pivot pin 15 or hub is hinged to the spacer element 7 at the end opposite the first wheel 3.

Each spacer element 7 radially spaces the pivot pin 15 or hub from the shaft 17, thus creating an arm between the shaft 17 and the pivot pin 15.

The hinge shaft 17 is hinged to the frame 1 so that the rotation axis X-X of the couple of first wheels 3 can rotate, through the rotation of the spacer elements 7, with respect to the hinge shaft 17 and vice-versa.

According to an embodiment shown in the figures, the swinging device 5 comprises a first assembly for locking the rotation of the spacer elements 7 and consequently the rotation of the rotation axis X-X of the first wheels 3 with respect to the hinge shaft 17.

In the embodiment shown in the figures, the assembly for locking the rotation of the spacer elements 7 with respect to the hinge shaft 17 comprises a head portion 19 arranged on at least one spacer element 7 and a clamp element 16.

In the embodiment, there are two head portions 19, one for each spacer element 7, and two clamp elements 16.

The clamp element 16 is movable between a first position, in which it is engaged with the head portion 19 and locks the rotation of the spacer element 7, and a second position in which it is away from the first head portion 19, thus releasing the rotation of the spacer element 7.

According to an embodiment, the head portion 19 consists of a cogged rack 19′ and is shaped so that to be able to couple with a corresponding cogged portion 20 provided on the clamp element 16.

To this end, the cogged portion 20 is facing the cogged rack 19′.

During the reciprocal coupling of the teeth of the cogged rack 19′ and of the cogged portion 20, the rotation of the spacer elements 7 is locked with respect to the shaft 17 and, consequently, the rotation of the rotation axis X-X of the first wheels 3 with respect to the hinge axis Y-Y.

In this position, unless the limiting means for limiting the rotation, more clearly described hereunder, are activated, the position of the rotation axis X-X is substantially fixed with respect to the position of the hinge axis Y-Y. In this configuration the first wheels 3 are however allowed to rotate each with respect to its pin 15 and consequently with respect to the rotation axis X-X. According to this configuration, the carriage proceeds traditionally, with the crib or seat neither swinging with respect to the frame 1 nor with respect to the ground.

The swinging device 5 according to the present invention can provide limiting means to limit the rotation of the rotation axis X-X with respect to the hinge axis Y-Y.

In other words, the limiting means for limiting the rotation are configured so that to angularly limit the rotation of the spacer elements 7 with respect to the shaft 17.

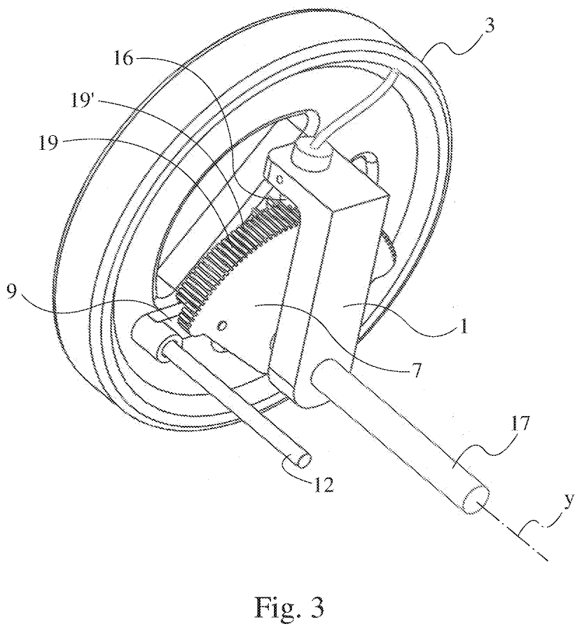

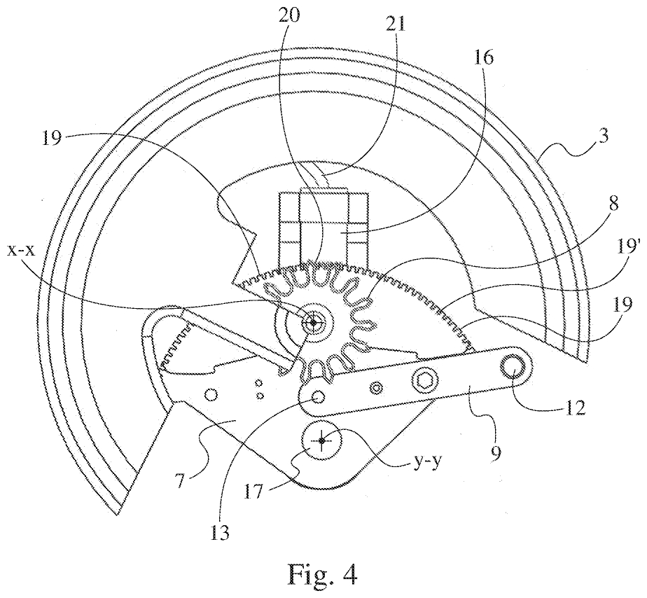

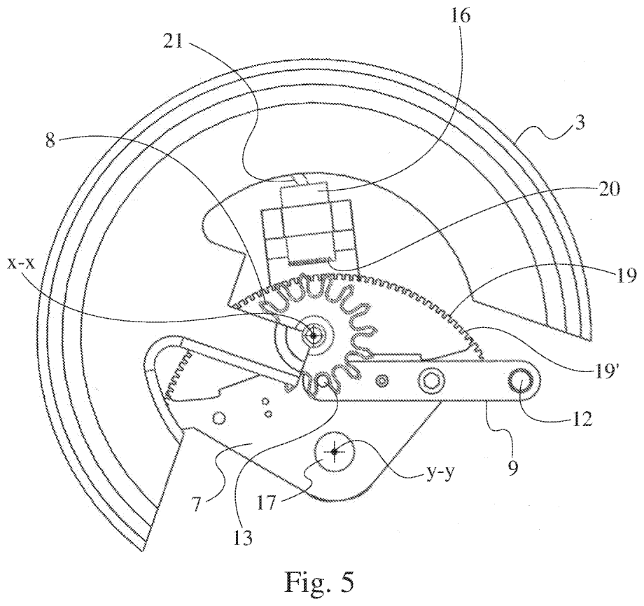

According to an embodiment shown in the FIGS. 1-7, the limiting means for limiting the rotation have at least one crown wheel 8 and at least one rocker lever 9.

In the embodiment shown in the figures, there are two crown wheels 8, each fixed to a first wheel 3 so that to be integral with a first wheel 3. There further are two rocker levers 9, each having two ends and each being hinged in a position, preferably intermediate between the two ends, to a spacer element 7 so that to be able to rotate with respect to the latter.

In detail, each rocker lever 9 has a first end 9′ having a countering element 13 and a second end 11 engaged with a drive shaft 12.

The rocker lever 9 is hinged to the spacer element 7 so that to be able to rotate the first end between a first position, in which the first end 9′, and in particular the countering element 13, are engaged with the crown wheel 8 thus limiting the rotation of the rotation axis X-X of the first couple of wheels with respect to the hinge axis Y-Y, and a second position in which the first end, and in particular the countering element 13, are disengaged from the crown wheel 8, thus allowing the rotation of the rotation axis X-X with respect to the hinge axis Y-Y.

In the embodiment shown in the figures, each rocker lever 9 has a second end 11 engaged with a drive shaft 12.

The drive shaft connects the two rocker levers 9 so that a pressure exerted on the drive shaft 12 rotates each rocker lever 9 in order to engage the first end, and in particular the countering element, of each lever 9 with the crown wheel 8 and a pressure exerted on the drive shaft 12, in the opposite direction with respect to the previous one, rotates the drive levers 9 so that to disengage the first end from the crown wheel 8.

The activation of the clamp element 16 can be controlled by an appropriate device provided on the handle of the carriage, by a tie string and by an elastic return element, not shown in the figure.

The tie string 21 operated by the device translates the clamp element 16 from the position of engagement with the cogged rack 19′ to the second position in which the clamp element 16, and in particular the cogged portion 20, is away and disengaged from the cogged rack 19′. The elastic element is loaded during this movement.

When the drive device releases the tie string 21, the elastic element pushes on the clamp element 16, thus making it translate from the second position to the first position in which the cogged rack 19′ and the cogged portion 20 are engaged.

The carriage 10 according to the present invention in the embodiment shown in the figures thus has four configurations.

In the first configuration, the clamp elements 16 are in their first position, i.e. engaged with the first head portion 19, while the limiting means are deactivated, i.e. disengaged from the cogwheel 8.

In this configuration, the angular position of the rotation axis X-X is substantially fixed with respect to the position of the hinge axis Y-Y.

In other words, the angular position of the spacer elements is fixed with respect to the hinge shaft. According to this configuration, the carriage proceeds traditionally with the crib or seat neither swinging with respect to the frame 1 nor with respect to the ground.

In the second configuration, the clamp elements 16 are in their second position, i.e. disengaged from the first head portion 19, while the limiting means are activated, i.e. engaged with the cogwheel 8.

In this configuration, the angular position of the rotation axis X-X can rotate, although limitedly, with respect to the position of the hinge axis Y-Y.

In other words, the angular position of the spacer elements 7 varies, although according to a limited travel, with respect to the hinge shaft 17. According to this configuration, the carriage can limitedly proceed forward and backward, following the thrust of the driver, thus making the crib or seat swing with respect to the frame 1 and with respect to the ground.

In the third configuration, which can be operated by the first or the second configuration, the clamp elements 16 are in their first position, i.e. engaged with the first head portion 19, and the limiting means are activated, i.e. engaged with the cogwheel 8.

In this configuration, the carriage is locked with respect to the travel direction and the crib or seat have not movement.

Finally, in the fourth configuration, the clamp elements 16 are in their second position, i.e. disengaged from the first head portion 19 and the limiting means are deactivated, i.e. disengaged from the cogwheel 8.

In this configuration, the angular position of the rotation axis X-X can rotate freely with respect to the position of the hinge axis Y-Y.

In other words, the angular position of the spacer elements 7 varies with respect to the hinge shaft 17 depending on the irregularities of the ground. In fact, according to this configuration, the carriage 10 can proceed traditionally, a bump or discontinuity of the ground makes the spacer elements 7 rotate with respect to the hinge shaft 17 and consequently makes the crib or seat of the carriage 10 rotate with respect to the frame 1.

Several changes can be made to the embodiments described in detail, anyhow to remaining within the protection scope of the invention, defined by the following claims.

1. Carriage (10) for children equipped with at least one frame (1), at least one couple of first wheels (3), at least one pivot pin (15) on which the first wheels (3) are mounted, defining a rotation axis (X-X) of the first wheels (3), at least one hinge axis (Y- Y) for hinging the frame to said at least one couple of first wheels (3) through at least one spacer element (7), characterized by comprising at least one swinging device (5) and at least one drive device to drive said swinging device (5);
said swinging device (5) comprising said at least one spacer element (7) configured to space said rotation axis (X-X) from said hinge axis (Y-Y); said swinging device (5) being configured so that to switch from a first configuration, in which the position of the rotation axis (X-X) is substantially fixed with respect to the position of the hinge axis (Y-Y); to a second configuration in which the rotation axis (X-X) of the first wheels (3) rotates by a predetermined angular amount with respect to the hinge axis (YY) and/or vice-versa keeping said first wheels (13) in contact with the ground.

2. Carriage (10) for children according to claim 1, characterized in that said swinging device (5) comprises limiting means to limit the rotation of the rotation axis (X- X) of the first wheels (3) with respect to the hinge axis (Y-Y).

3. Carriage (10) for children according to claim 1, characterized by comprising an assembly for locking the rotation of the rotation axis (X-X) of the first wheels (3) with respect to the hinge axis (Y-Y), which is configured to lock the rotation of said at least one spacer element (7).

4. Carriage (10) for children according to claim 1, characterized in that said assembly for locking the rotation comprises a first head portion (19) arranged on said spacer element (7) and a clamp element (16) shaped to translate from a first position, in which it is engaged with said first head portion (19) and locks the position of the spacer element (7), and a second position in which it is away from the first head portion (19), thus releasing the rotation of the spacer element (7).

5. Carriage (10) for children according to claim 1, characterized by comprising two pivot pins (15), one for each first wheel (3), said rotation axis (X-X) of the first wheels (3) passing through said two pivot pins (15).

6. Carriage (10) for children according to claim 2, characterized in that said limiting means to limit the rotation comprise:
at least one crown wheel (8) integral with a first wheel (3);
at least one lever (9) comprising a first end (9′); said lever (9) being hinged to said spacer element (7) to rotate said first end between a first position, in which said first end (9′) is engaged with said crown wheel (8) and limits the rotation of the rotation axis (X-X) of the first couple of wheels (3) with respect to the hinge axis (Y-Y), and a second position in which said first end (9′) is disengaged from the crown wheel (8), thus allowing the rotation of the rotation axis (X-X) with respect to the hinge axis (Y-Y).

7. Carriage (10) for children according to claim 6, characterized in that said lever (9) comprises a second end (11) engaged with a drive shaft (12) arranged so that a pressure exerted on the drive shaft (12) rotates the lever in order to engage the first end with the crown wheel (8) and a pressure exerted on the drive shaft (12), in the opposite direction with respect to the previous one, rotates said lever (9) so that to disengage the first end from said crown wheel (8).

8. Carriage (10) for children according to claim 4, characterized in that said head portion (19) comprises a cogged rack and said clamp element (16) comprises a cogged portion (20) shaped to be engaged with said cogged rack.

9. Carriage (10) for children according to claim 1, characterized by comprising a hinge shaft (17) for hinging said at least one spacer element (7) to the frame (1); said hinge axis (Y-Y) passing through said hinge shaft (17).

10. Carriage (10) for children according to claim 1, characterized in that said assembly for locking the rotation of the rotation axis comprises an elastic element to push said clamp element (16) towards said second position.
